(19) United States
(12) Patent Application Publication
(10) Pub. No.: US 2024/0116332 A1
(43) Pub. Date: Apr. 11, 2024

(54) VEHICULAR IN-CABIN HEATING SYSTEM USING ADAS ECU

(71) Applicant: Magna Electronics Inc., Auburn Hills, MI (US)

(72) Inventor: Naresh Ravuri, Novi, MI (US)

(21) Appl. No.: 18/482,997

(22) Filed: Oct. 9, 2023

Related U.S. Application Data
(60) Provisional application No. 63/379,009, filed on Oct. 11, 2022.

(51) Int. Cl. B60H 1/22; B60H 1/00

(52) U.S. Cl. CPC B60H 1/2225; B60H 1/00021; B60H 1/00735; B60H 2001/0015

(57) ABSTRACT

A vehicular climate control system includes an airflow source operable to provide airflow within an interior cabin of a vehicle. An electronic control unit module (ECU module) is disposed at the vehicle and includes a heat-generating electronic component that, when the ECU module is electrically operated, generates heat at the ECU module. When the ECU module is electrically operated and the heat-generating electronic component of the ECU module generates heat at the ECU module and when the vehicular climate control system operates the airflow source to provide the airflow within the interior cabin of the vehicle, heat generated at the ECU module is dissipated from the ECU module and heats the airflow provided within the interior cabin of the vehicle.

### CROSS REFERENCE TO RELATED APPLICATION

The present application claims the filing benefits of U.S. provisional application Ser. No. 63/379,009, filed Oct. 11, 2022, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of sensors in vehicle sensing systems is common and known. Examples of such known systems are described in U.S. Pat. Nos. 5,949,331; 5,670,935 and/or 5,550,677, which are hereby incorporated herein by reference in their entireties. Heat is generated during operation of the electronic control units and data processors that process data captured by cameras or sensors of the sensing systems.

### SUMMARY OF THE INVENTION

A vehicular climate control system includes an airflow source disposed at a vehicle equipped with the vehicular climate control system. The airflow source is configured to provide airflow to a cabin of the vehicle. The vehicular climate control system is operable to provide a heating airflow to the cabin of the vehicle based on a target temperature for the cabin and a current temperature of the cabin. The system, when the target temperature is greater than the current temperature, is operated to provide the heating airflow to the cabin. An electronic control unit module (ECU module) is disposed at the vehicle and includes electronic circuitry that includes at least one heat generating electronic component that, when the ECU module is electrically operated, generates heat at the ECU module. The at least one heat generating electronic component may include a data processor that processes sensor data captured by a sensor at the vehicle, such as for an advanced driving assistance system (ADAS) of the vehicle. When the ECU module is electrically operated and the heat generating electronic component generates heat, and when the climate control system is operated to provide the heating airflow, heat generated at the ECU module is dissipated from the ECU module and heats the heating airflow provided to the cabin.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a vision system that incorporates an imaging sensor; and

FIG. 2 is a perspective view of the vehicle of FIG. 1, showing airflow from a heating, ventilation, and air conditioning (HVAC) system of the vehicle.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

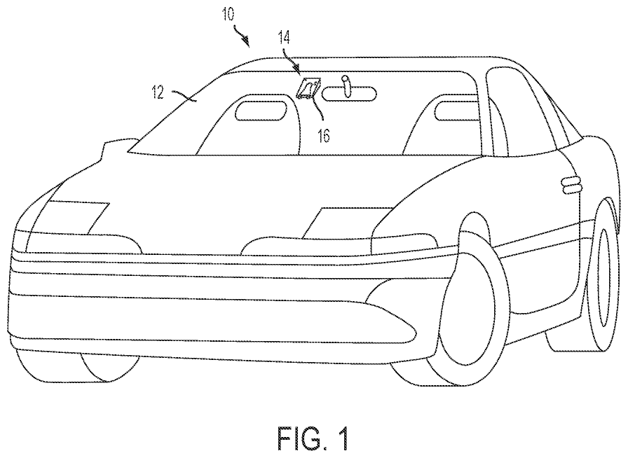

Referring now to the drawings and the illustrative embodiments depicted therein, a vision system 14 for a vehicle 10 includes at least one exterior viewing imaging sensor or camera, such as a forward viewing imaging sensor or camera, which may be disposed at and behind the windshield 12 of the vehicle 10 and viewing forward through the windshield 12 so as to capture image data representative of the scene occurring forward of the vehicle (FIG. 1). Optionally, the system 14 may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. The camera or cameras each include a lens for focusing images at or onto an imaging array or imaging plane or imager of the camera. The forward viewing camera may be part of a camera module or windshield mounted electronics module (WEM) 16 disposed at the windshield 12 of the vehicle 10 and views through the windshield 12 and forward of the vehicle 10, such as for a machine vision system (such as for traffic sign recognition, headlamp control, pedestrian detection, collision avoidance, lane marker detection and/or the like). The vision system 14 includes a control or electronic control unit (ECU) having electronic circuitry and associated software, with the electronic circuitry including a data processor or image processor that is operable to process image data captured by the camera or cameras, whereby the system, via processing of the captured sensor data at the ECU, may detect or determine presence of objects or the like and/or the system provide displayed images at a display device for viewing by the driver of the vehicle. The camera module 16 may accommodate the ECU or the ECU may be disposed at any suitable location at the vehicle. The data transfer or signal communication from the camera to the ECU may comprise any suitable data or communication link, such as a vehicle network bus or the like of the equipped vehicle.

Advanced driving assistance systems (ADAS) or vision systems include a significantly increasing number of features and perform an increasing number of functions to both provide additional functionality to consumers and also to meet industry standards and governmental regulations. Additionally, a common or singular or central ECU may process data from various sensors in the vehicle (e.g., exterior viewing camera module, radar sensors, driver/cabin monitoring camera, surround view system cameras, cameras for camera monitoring systems (CMS), and the like) to provide the additional functionality. For example, the ECU module may include one or more printed circuit boards (PCBs) accommodating one or more integrated chips or integrated circuits (ICs) or electronic components to provide the increased processing. An increased number of features and functions results in a higher demand for processing speed and increased power consumption by ECUs and ADAS modules and these electronic components generate heat when electrically operated to perform the functions of the ECU. When the ECU provides the additional functionality and increased processing, this will result in greater heat generation at the ECU module. The ECU or electronics module or camera module may include a cooling system or cooling features to maintain a safe operational temperature of the ECU, such as by utilizing aspects of the systems and ECU modules described in U.S. Pat. No. 11,290,622 and/or U.S. Publication Nos. US-2022-0239817 and/or US-2021-0306538, which are hereby incorporated herein by reference in their entireties.

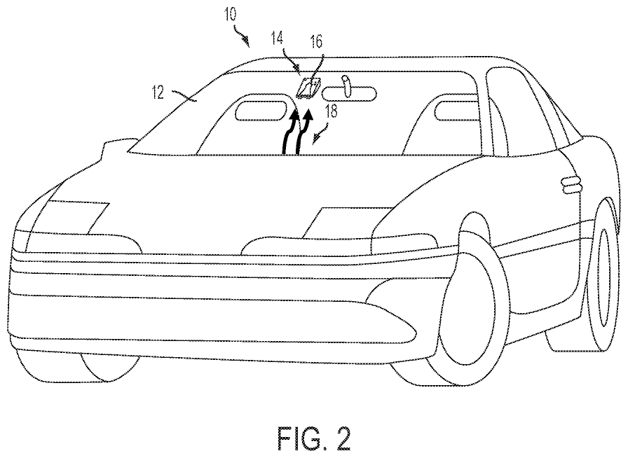

As shown in FIG. 2, to maintain an acceptable operating temperature of the ECU and to conserve energy used in heating the cabin of the vehicle, a climate control system 18 of the vehicle 10, such as a heating, ventilation, and air conditioning (HVAC) system of the vehicle, may utilize heat generated by the ECU to heat airflow supplied to heat the cabin of the vehicle. In other words, heat generated by the ECU may be used to at least partially heat the cabin of the vehicle.

The ECU or camera module 16 includes one or more heat generating electronic components that generate heat at the camera module 16 when electrically operated, and the camera module 16 includes one or more cooling or heat dissipating features thermally conductively coupled to the heat generating components to dissipate heat away from the ECU or camera module 16. For example, the ECU or camera module may include a housing accommodating one or more PCBs that include respective heat generating components (e.g., one or more processors, such as an image processor or other data processor, an image sensor, and the like) and the housing may include heat dissipating fins configured to dissipate heat from the one or more heat generating electronic components disposed at the PCBs.

Further, the HVAC system 18 of the vehicle is configured to provide cooling or heating airflow to the cabin of the vehicle based on a current ambient temperature of the cabin of the vehicle and a target cabin temperature indicated by the system. The HVAC system 18 may include a heating element and a cooling element that conditions an airflow supply directed toward the cabin of the vehicle. When the ECU is generating sufficient heat, such as when the ECU is experiencing a significant processing load, the HVAC system 18 may utilize heat generated at the camera module 16 instead of or to supplement usage of the heating element of the HVAC system 18.

The ECU may be disposed at any suitable position at the vehicle so that the heat generated by the ECU may be used to at least partially heat the airflow supply directed toward the cabin of the vehicle by the HVAC system 18. For example, the ECU or camera module 16 may be disposed at a central location, such as behind or within a dashboard or center console of the vehicle and in proximity to an air conduit carrying heated airflow to the cabin of the vehicle. The ECU or camera module 16 or heat dissipating features may be disposed along the air conduit to directly heat the airflow being carried to the cabin of the vehicle. That is, the airflow from the HVAC system 18 may pass directly along and between the heat dissipating fins of the ECU or camera module and the heat generated by the ECU may directly heat the airflow supplied to the cabin of the vehicle.

Optionally, the camera module 16 may include a fan assembly that provides cooling airflow at the ECU, such as by directing airflow along and between heat dissipating fins of the ECU. The airflow from the camera module fan assembly dissipates heat away from the ECU and the heated air may be mixed or directed toward the airflow that is supplied to the cabin of the vehicle. In other words, the heated airflow exhausted away from the camera module 16 may be combined with or otherwise used to heat the airflow provided to the cabin of the vehicle from the HVAC system.

Optionally, the camera module 16 is mounted to the windshield 12 of the vehicle and airflow dissipating heat from the ECU may be exhausted directly from the windshield mounted module to the cabin of the vehicle. Thus, the windshield mounted module includes a fan assembly that generates airflow within the camera module, and the airflow is directed within the camera module to dissipate heat away from the ECU. This heated airflow is then exhausted, such as passively or via an exhaust fan assembly, to the cabin of the vehicle. Operation of the HVAC system 18 may be adjusted based on the heated airflow exhausted from the camera module 16, such as to reduce the temperature and/or intensity of the airflow provided by the HVAC system 18 to the vehicle cabin when heating the vehicle while heated airflow is exhausted from the camera module 16.

As shown in FIG. 2, the HVAC system 18 may direct airflow to the cabin of the vehicle from an outlet disposed in the dashboard of the vehicle and the airflow may be directed along an in-cabin surface of the windshield. The airflow may be directed toward the windshield mounted module 16 so that heat generated by the ECU may heat the airflow and therefore heat the cabin of the vehicle.

Optionally, heat generated by the ECU may provide supplementary heat for the climate control system of the vehicle. That is, the HVAC system may partially heat the airflow directed toward the cabin of the vehicle and the heat generated by the ECU may provide partial, additional heating of the airflow, such as to maintain the temperature of the airflow as it travels toward the cabin of the vehicle, or to increase the temperature of the airflow.

The vision system 14 may communicate with the HVAC system or climate control system and, responsive to a signal from the HVAC system requesting heated airflow, operate the fan assembly to direct heated air toward the cabin of the vehicle or airflow supply of the HVAC system. A thermometer or temperature sensor may be disposed at the camera module 16. The HVAC system 18 may not utilize airflow heated by the ECU module when the HVAC system 18 is providing cooling airflow to the cabin of the vehicle (i.e., the airflow provided to the cabin is at a temperature that is less than the ambient temperature of the cabin of the vehicle and/or less than a current temperature at the ECU module). Put another way, the HVAC system may only utilize airflow heated by the ECU module when the HVAC system is providing heating airflow to the cabin of the vehicle (i.e., the airflow provided to the cabin is at a temperature that is greater than the ambient temperature of the cabin and/or greater than or equal to a current temperature at the ECU module). For example, vents connecting an air conduit of the HVAC system 18 to air heated by the ECU module 16 may be closed when the HVAC system 18 is providing cooled airflow to the cabin of the vehicle and the vents may be opened when the HVAC system 18 is providing heated airflow to the cabin of the vehicle. Optionally, cooling airflow from the HVAC system may be directed at the ECU to cool the operating temperature of the ECU.

Thus, high performance ECUs may be placed at a central location of the vehicle and air circulation to the vehicle cabin may be connected through or passed through the ECU's heat sink power dissipation. The heat sink attached to the ECU may be populated to the airflow pipe and air circulated through the heat sink may thus be heated without using a heat pump.

Optionally, passive cooling fans may be connected to the heated exhaust air outside of the ECU and this exhaust may be connected to the air circulation to heat the air circulation air. That is, exhaust fans may draw heated air away from the ECU and toward an air source providing airflow to the cabin of the vehicle. The exhaust air is mixed with the airflow for the cabin of the vehicle to heat the airflow for the cabin of the vehicle. This mechanism or connection should be enabled only during heating of the cabin and not when the cabin is being cooled.

Thus, the system provides energy savings for an energy system of the vehicle. For example, the number of miles per charge for the battery of an electric vehicle may be low when environment temperatures are low (e.g., during the winter) due to heavy usage of the battery for heating the cabin (e.g., via providing electrical current to a resistive heating element or via heat pump heating systems). The system allows for less or no energy or battery usage for in-cabin heating when heat generated by the ECU is used to heat the cabin. Thus, the system utilizes the heat generated by the already operating ECU and avoids additional power consumption for heating the interior cabin of the vehicle.

The system may include an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular climate control system, the vehicular climate control system comprising:
an airflow source disposed at a vehicle equipped with the vehicular climate control system, wherein the airflow source is operable to provide airflow within an interior cabin of the vehicle;
wherein an electronic control unit module (ECU module) is disposed at the vehicle and comprises electronic circuitry, and wherein the electronic circuitry comprises a heat-generating electronic component, and wherein the heat-generating electronic component, when the ECU module is electrically operated, generates heat at the ECU module; and
wherein, when the ECU module is electrically operated and the heat-generating electronic component generates heat at the ECU module, and when the vehicular climate control system operates the airflow source to provide the airflow within the interior cabin of the vehicle, heat generated at the ECU module is dissipated from the ECU module and heats the airflow provided within the interior cabin of the vehicle.

2. The vehicular climate control system of claim 1, wherein the vehicular climate control system operates the airflow source to provide the airflow within the interior cabin of the vehicle based on (i) a target temperature for the interior cabin of the vehicle and (ii) a current temperature of the interior cabin of the vehicle, and wherein the vehicular climate control system, when the current temperature is less than the target temperature, operates the airflow source to provide heating airflow to the interior cabin of the vehicle.

3. The vehicular climate control system of claim 2, wherein the airflow source is operable to provide a cooling airflow within the interior cabin of the vehicle, and wherein the vehicular climate control system, when the current temperature is greater than the target temperature, operates the airflow source to provide the cooling airflow within the interior cabin of the vehicle.

4. The vehicular climate control system of claim 1, wherein the airflow source provides the airflow within the interior cabin of the vehicle via an air conduit, and wherein the ECU module is in thermally conductive connection with the air conduit.

5. The vehicular climate control system of claim 4, wherein the ECU module comprises an exhaust fan that is operable to draw heated air away from the heat-generating electronic component and to direct the heated air from the ECU module toward the air conduit to heat the airflow provided within the interior cabin of the vehicle.

6. The vehicular climate control system of claim 5, wherein the exhaust fan directs the heated air from the ECU module along the air conduit to mix with the airflow from the airflow source.

7. The vehicular climate control system of claim 1, wherein the ECU module is mounted at a windshield of the vehicle, and wherein an exhaust fan is disposed at the ECU module and operable to direct heating airflow to the interior cabin of the vehicle, and wherein the vehicular climate control system, when the exhaust fan is operated to direct the heating airflow to the interior cabin of the vehicle, adjusts operation of the airflow source to reduce a portion of the airflow within the interior cabin of the vehicle provided by the airflow source.

8. The vehicular climate control system of claim 1, wherein the heat generating electronic component comprises a data processor that, when the ECU module is electrically operated, processes sensor data captured by a sensor at the vehicle for a system of the vehicle.

9. The vehicular climate control system of claim 8, wherein the system comprises an advanced driving assistance system (ADAS) of the vehicle.

10. The vehicular climate control system of claim 8, wherein the sensor comprises an image sensor.

11. The vehicular climate control system of claim 1, wherein the ECU module comprises a heat sink in thermally conductive connection with the heat generating electronic component, and wherein the heat sink dissipates heat generated at the ECU module, and wherein the airflow source directs the airflow along the heat sink to heat the airflow provided within the interior cabin of the vehicle.

12. The vehicular climate control system of claim 1, comprising a heating element operable to generate heat to at least partially heat the airflow provided by the airflow source within the interior cabin of the vehicle, and wherein the vehicular climate control system adjusts operation of the heating element to adjust a level of heat generated at the heating element based on a level of heat generated at the ECU module.

13. The vehicular climate control system of claim 12, wherein the vehicular climate control system adjusts operation of the heating element to reduce the level of heat generated at the heating element based on an increased level of heat generated at the ECU module.

14. A vehicular climate control system, the vehicular climate control system comprising:
an airflow source disposed at a vehicle equipped with the vehicular climate control system, wherein the airflow source is operable to provide airflow within an interior cabin of the vehicle;
wherein the vehicular climate control system operates the airflow source to provide the airflow within the interior cabin of the vehicle based on (i) a target temperature for the interior cabin of the vehicle and (ii) a current temperature of the interior cabin of the vehicle, and wherein the vehicular climate control system, when the current temperature is less than the target temperature, operates the airflow source to provide heating airflow to the interior cabin of the vehicle;
wherein an electronic control unit module (ECU module) is disposed at the vehicle and comprises electronic circuitry, and wherein the electronic circuitry comprises a heat-generating electronic component, and wherein the heat-generating electronic component, when the ECU module is electrically operated, generates heat at the ECU module;
wherein the airflow source provides the airflow within the interior cabin of the vehicle via an air conduit, and wherein the ECU module is in thermally conductive connection with the air conduit; and
wherein, when the ECU module is electrically operated and the heat-generating electronic component generates heat at the ECU module, and when the vehicular climate control system operates the airflow source to provide the heating airflow within the interior cabin of the vehicle, heat generated at the ECU module is dissipated from the ECU module and heats the airflow provided within the interior cabin of the vehicle.

15. The vehicular climate control system of claim 14, wherein the ECU module comprises an exhaust fan that is operable to draw heated air away from the heat-generating electronic component and to direct the heated air from the ECU module toward the air conduit to heat the airflow provided within the interior cabin of the vehicle.

16. The vehicular climate control system of claim 15, wherein the exhaust fan directs the heated air from the ECU module along the air conduit to mix with the airflow from the airflow source.

17. The vehicular climate control system of claim 14, wherein the ECU module comprises a heat sink in thermally conductive connection with the heat generating electronic component, and wherein the heat sink dissipates heat generated at the ECU module, and wherein the airflow source directs the airflow along the heat sink to heat the airflow provided within the interior cabin of the vehicle.

18. A vehicular climate control system, the vehicular climate control system comprising:
an airflow source disposed at a vehicle equipped with the vehicular climate control system, wherein the airflow source is operable to provide airflow within an interior cabin of the vehicle;
a heating element operable to generate heat to at least partially heat the airflow provided by the airflow source within the interior cabin of the vehicle;
wherein an electronic control unit module (ECU module) is disposed at the vehicle and comprises electronic circuitry, and wherein the electronic circuitry comprises a heat-generating electronic component, and wherein the heat-generating electronic component, when the ECU module is electrically operated, generates heat at the ECU module;
wherein the airflow source provides the airflow within the interior cabin of the vehicle via an air conduit, and wherein the ECU module is in thermally conductive connection with the air conduit; and
wherein, when the ECU module is electrically operated and the heat-generating electronic component generates heat at the ECU module, and when the vehicular climate control system operates the airflow source to provide the airflow within the interior cabin of the vehicle, heat generated at the ECU module is dissipated from the ECU module and heats the airflow provided within the interior cabin of the vehicle, and wherein the vehicular climate control system adjusts operation of the heating element to adjust a level of heat generated at the heating element based on a level of heat generated at the ECU module.

19. The vehicular climate control system of claim 18, wherein the vehicular climate control system operates the airflow source to provide the airflow within the interior cabin of the vehicle based on (i) a target temperature for the interior cabin of the vehicle and (ii) a current temperature of the interior cabin of the vehicle, and wherein the vehicular climate control system, when the current temperature is less than the target temperature, operates the airflow source to provide heating airflow to the interior cabin of the vehicle.

20. The vehicular climate control system of claim 18, wherein the vehicular climate control system adjusts operation of the heating element to reduce the level of heat generated at the heating element based on an increased level of heat generated at the ECU module.
